(19) United States
(12) Patent Application Publication
(10) Pub. No.: US 2012/0132689 A1
(43) Pub. Date: May 31, 2012

(54) FASTENER DRIVING TOOL

(75) Inventors: Tilo Dittrich, Feldkirch (AT); Thomas Sperrfechter, Grusch (CH); Heeb Norbert, Buchs (CH); Peter Stauss, Feldkirch (AT)

(73) Assignee: HILTI AKTIENGESELLSCHAFT, Schaan (LI)

(21) Appl. No.: 13/302,270

(22) Filed: Nov. 22, 2011

(30) Foreign Application Priority Data
Nov. 25, 2010 (DE) 102010061942.6

(51) Int. Cl. B25C 1/14; B25C 1/18

(52) U.S. Cl. 227/10

(57) ABSTRACT

The invention relates to a fastener driving tool comprising a tank (5) for storing a fuel, in particular liquefied petroleum gas, a combustion chamber (2) connected to the tank (5), wherein the combustion chamber (2) has a movable piston for powering a driving plunger, and a metering device (4) arranged between the tank (5) and the combustion chamber (2) wherein a defined quantity of fuel can be transported by means of the metering device (4) from a metering space (12) into the combustion chamber (2), and wherein the metering device (4) comprises a movable displacement member (16) for ejecting the fuel out of the metering space (12), wherein the movement of the displacement member (16) is supplied by the pressure of the fuel as the energy source.

The invention relates to a fastener driving tool, more particularly a hand-held fastener driving tool according to the preamble of claim 1.

DE 102 60 703 A1 describes a liquefied petroleum gas-driven fastener driving tool that has a metering chamber with an adjustable metered volume. The metered volume can be varied by an electric motor drive, and an ejection of liquefied petroleum gas into a combustion chamber is initiated by a pneumatic drive by means of compressed air.

The problem of the invention is to specify a fuel-driven fastener driving tool that operates simply and reliably.

This problem is solved for a fastener driving tool of the type mentioned above by the characterizing features of claim 1. The use of the fuel pressure as the energy source for driving the displacement member makes an effective and fast transport of the metered fuel into the combustion chamber possible in an easy manner.

This makes it cost-effectively possible to forgo additional drive mechanisms, such as electrical and pneumatic drives, for the displacement member. Finally, the mechanical energy stored in the fuel tank is intelligently used to enable the metering of the fuel into the combustion chamber quickly and precisely.

A displacement member within the meaning of the invention is understood to be any movable component by means of which fuel can be ejected from the metering space.

In a preferred embodiment, the displacement member can be constructed as a linearly displaceable reciprocating pisto, for example, that is guided in a cylinder forming the metering space, at least in part. In this case, the fuel would be directly forced out of the metering space by the displacement member. Alternatively, however, the metering space itself can be constructed to be variable, for example as a collapsible bellows or as a volume with an elastic wall. In such configurations, the displacement member can be constructed as an actuating plunger deforming the metering space, for example. In a preferred embodiment, the elastic wall itself forms the displacement member, specifically, by application of pressure from the side opposite the metering space.

It is preferably assumed within the meaning of the present invention that the fuel is metered predominantly or exclusively in the liquid phase, whereby the amount of fuel introduced into the combustion chamber is defined especially precisely. With liquefied petroleum gas as the fuel, such an exclusive metering in the liquid phase can be ensured, for example, by arranging a diaphragm in the fuel tank, wherein the liquefied petroleum gas is kept exclusively in the liquid phase inside the diaphragm and an inert gas under a defined positive pressure is provided outside the diaphragm, for example. As the fuel is consumed, the inert gas expands and, due to its positive pressure, keeps the liquefied petroleum gas in the liquid phase at all times. Such a conventionally known configuration of a fuel tank is accompanied in practice as a matter of course by a certain variation of the pressure in the fuel tank as it is being emptied. That constitutes a difference from conventional storage containers for liquefied petroleum gas, in which liquefied gas is stored in a coexistence of gaseous and liquid phases in a constant volume, and thus provides a constant pressure.

In one possible embodiment of the invention it is provided that a drive unit of the displacement member comprises a rechargeable mechanical energy accumulator, with the energy accumulator being recharged by the pressure of the fuel. In a preferred detailed design, the mechanical energy accumulator can comprise a mechanical spring, a pneumatic spring or a magnetic spring. This guarantees a particularly defined ejection process of the liquid fuel into the combustion chamber. The ejection can preferably be initiated by simple opening of a valve. Alternatively or additionally, the mechanical energy accumulator can also comprise an additional support device by means of which it can be triggered.

In another preferred embodiment of the invention, the displacement member can be directly driven by a pressure of the fuel, preferably via a connection to the fuel tank. This provides a mechanically simple driving of the displacement member. As also in the case where a mechanical intermediate accumulator for the drive energy is used, the fuel can easily be ejected from the metering space by opening a valve.

In an expedient refinement, the displacement member can be held in an initial position under a force, preferably but not necessarily by means of a spring. In a simple manner, this ensures a defined starting position of the displacement member before initiation of the metering process.

In a generally advantageous detailed design, the metering device comprises at least one valve member, the valve member being preferably driven electrically. The metering space can preferably be blocked off from the combustion chamber by the valve member, in which case the ejection process for the fuel can be triggered by the opening of this barrier, for example.

Further advantageously, the valve member can be constructed as a three-way valve, in particular with two switching positions, in the interest of a simple and effective realization. Overall this allows a simple and reliable control of the metering device. Further advantageously, the two switching positions of the three-way valve can be configured as bistable positions, whereby a particularly low consumption of electric energy for the valve member becomes possible.

In a preferred refinement, the defined quantity of fuel is adjustably variable, by means of a variable stop for the displacement member, for example. In this manner it is possible to react specifically to changed environmental conditions such as the ambient temperature. In particular, the defined quantity of fuel can be increased in case of a decreasing ambient temperature in order to be able to provide an ignitable mixture in the combustion chamber sufficiently quickly, even when evaporation of the fuel is retarded. Depending on requirements, the stop can be adjusted by a thermomechanical element, e.g., a bimetallic element or an expansion material element, or by means of an electrical adjustment drive, preferably a stepper motor. It is provided in a generally advantageous manner that a characteristic curve of the defined fuel quantity as a function of an ambient temperature has a substantially bilinear progression.

This can be advantageously used so that the metered fuel quantity is varied only in the low temperature range, for example, while a constant amount of fuel is metered after reaching a certain limit temperature, in the range of an ambient temperature of 20° C. for example.

Further advantages and characteristics of the invention follow from the exemplary embodiments described below, and from the dependent claims.

Several exemplary embodiments of the invention will be described below and explained in detail with reference to the attached drawings.

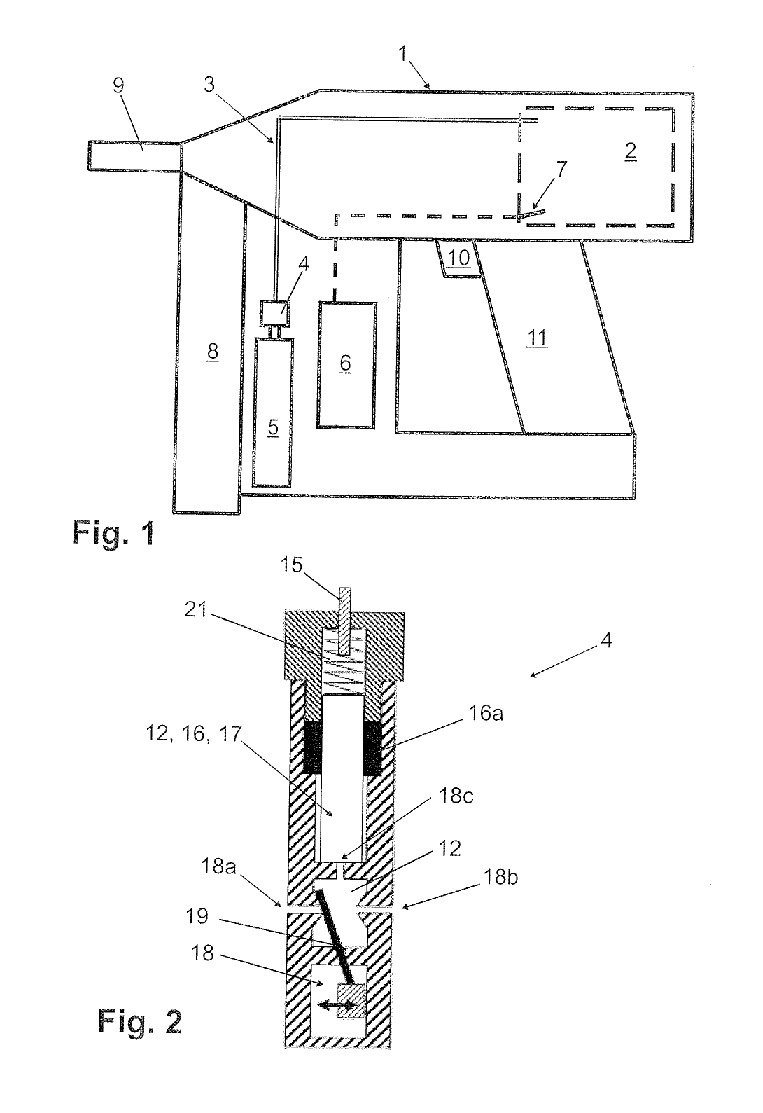

FIG. 1 illustrates a schematic overall view of a fastener driving tool according to the invention.

FIG. 2 illustrates a schematic representation of a first embodiment of the invention with a mechanical energy accumulator.

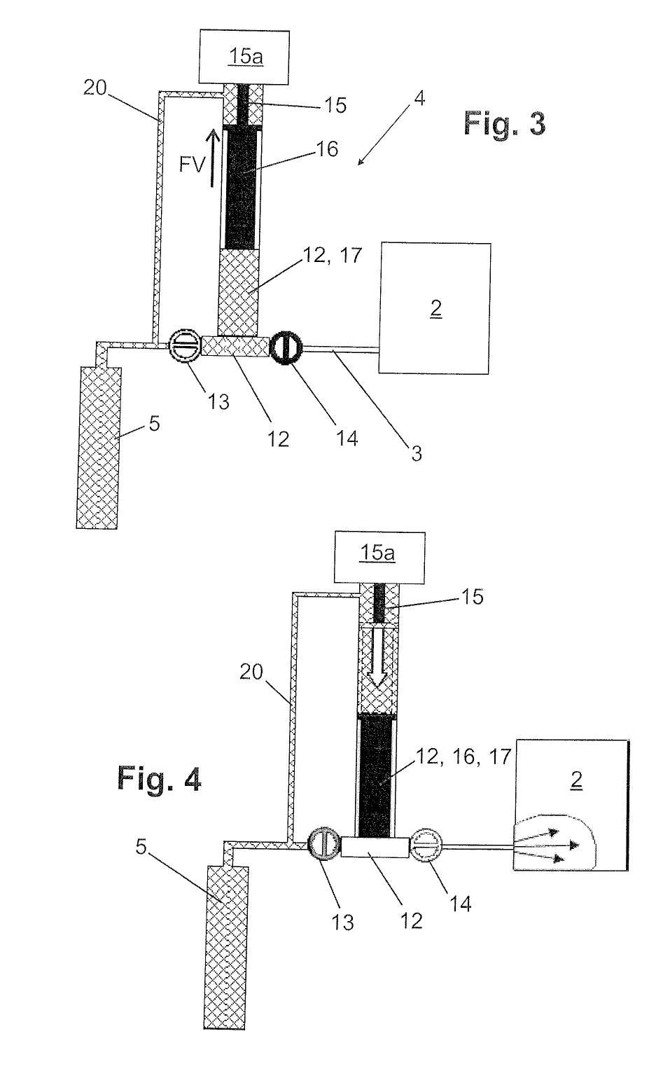

FIG. 3 illustrates a second exemplary embodiment of the invention in a standby state of the metering device.

FIG. 4 illustrates the exemplary embodiment from FIG. 3 during a metering of the fuel.

The fastener driving tool shown schematically in FIG. 1 comprises a housing 1 in which a combustion chamber 2 is arranged. Liquefied petroleum gas is stored as fuel in a fuel tank 5 and can be injected into the combustion chamber 2 via a line 3. The line 3 connects a metering device 4 to the combustion chamber 2, the metering device 4 being in turn connected to a fuel tank 5 arranged in or on the housing 1. In particular, the fuel tank can be constructed as a replaceable cartridge.

The fastener driving tool further comprises an electronic controller 6 with an electrical storage battery as the energy accumulator. The electronic controller 6 controls a spark plug 7 in the combustion chamber 2, and optionally the metering device 4 as well, if the latter has electric valves or other electrically controlled components. A magazine 8 for storing fastening means such as nails is arranged in an anterior area of the driving tool. A contact member 9 can be pressed against a workpiece in order to enable triggering of the fastener driving tool.

A fastening member from the magazine 8 is driven in by the ignition of a liquid petroleum gas-air mixture in the combustion chamber 2 by means of the spark plug 7, after which a piston (not shown) is driven forward and drives the fastening member or the nail into the workpiece via a driving plunger (not shown). This driving process is initiated by an operator via a switch 10, which is arranged in a handle area 11 of the housing 1 in this case.

FIG. 2 shows a first exemplary embodiment of the metering device 4. The metering device 4 comprises a metering space 12 that is connected via a three-way valve 18 with two switching positions 18 firstly to the fuel tank 5 via a feed line 18a, and secondly to the combustion chamber 2 via a feed line 18b. A valve slide 19 is arranged in a slide chamber that is part of the metering space 12. A third feed line 18c connects the slide chamber 12 to a cylindrical space 17 in which a displacement member 16 in the form of a reciprocating piston is guided. The space 17 forms an additional part of the metering space 12, wherein a movement of the displacement member 16 into the space 17 can eject the fuel located therein. FIG. 2 shows the displacement member 16 in the position maximally advanced into the cylinder 17.

The valve slide 19 is electrically actuated and can assume two defined positions. In the first position, which is shown in FIG. 2, the feed line 18a is closed and the feed line 18b is opened. In the other position, not shown, the feed line 18a is opened and the feed line 18b is closed. The connection 18c between the slide chamber and the cylinder 17 is permanently opened.

Depending on requirements, the positions of the valve slide 19 can each be stable positions (bistable valve slide) so that only a short electrical pulse requiring little energy is necessary to change the valve over. In another embodiment, the valve slide 19 is always arranged in a de-energized rest position, i.e., closing the connection 18b to the combustion chamber 2 (monostable valve slide). By applying an electrical voltage, the valve slide is brought into the opposite position (see FIG. 2), in which it closes the connection 18a to the fuel tank 5.

The reciprocating piston, or displacement member, 16 is subjected to force in the ejection direction by means of a spring 21, a helical spring in the present case.

In the direction opposite to the ejection direction or the force of the spring 21, the path of the reciprocating piston 16 is limited by an adjustable stop 15. The stop 15 is constructed as a linearly adjustable pin that can be connected, for example, to a thermomechanical element or an electrical adjustment device. The stop 15 can project further at higher ambient temperatures and thus reduce the possible stroke of the reciprocating piston 16, and can enlarge it at lower temperatures. In this way a defined quantity of fuel, determined by the stroke of the displacement member 16 in the cylinder 17, can be varied specifically.

The reciprocating piston 16 is slidingly guided in a seal 16a, so that its end facing the spring 21 is under ambient pressure, the seal 16a forming a barrier between the liquefied petroleum gas and the surroundings. Alternatively to a sliding seal, a different type of seal, for example a closed bellows, can also be selected.

The metering device according to FIG. 2 functions as follows:

Initially, the valve member 18 is brought by means of the controller 6 into the position, not shown, in which the slide chamber 12 is connected to the fuel tank and the combustion chamber is disconnected from the metering space 12. Liquefied petroleum gas can then flow in the liquid phase into the metering space 12 adjusted with the stop 15.

The liquefied petroleum gas in tank 5 is present only in the liquid phase. This is accomplished in a conventional manner by enclosing the liquefied petroleum gas in the tank in a diaphragm and filling the area outside the diaphragm with an inert gas under a pressure higher than the vapor pressure of the liquefied petroleum gas. Due to this positive pressure, no evaporation process takes place following the flowing of the liquefied petroleum gas into the metering space 12, so that there is substantially no change of temperature following the flowing of the liquid gas.

The inflowing liquefied petroleum gas presses the reciprocating piston 16 upwards (in the representation FIG. 2) as far as the stop 15 against the force of the spring 21, while filling up the free part of the cylinder 17 as metering space 12. In this upper position, the metering device is in readiness to eject the fuel into the combustion chamber. The spring 21 is tensioned, interim-storing mechanical energy that was removed from the pressurized fuel tank during the movement of the reciprocating piston 17.

If the fastener driving tool is triggered by actuating the switch 10, the valve slide 19 is changed over by means of the controller 6. In the process, the feed line 18a is closed and the feed line 18b is opened (see position in FIG. 2). Thus the liquefied petroleum gas flows into the combustion chamber 2, driven by its vapor pressure in addition to the spring force of the spring 21, which rapidly pushes the displacement member 16 downward into the cylinder 17 filled with liquefied petroleum gas.

The amount of liquid metered into the combustion chamber 2, depending on the adjustment of the stop 15, is larger at lower temperatures so that, even with a slower evaporation and/or a higher oxygen concentration in the combustion chamber, an ignitable mixture is provided in the combustion chamber 2 sufficiently quickly.

Then the liquid petroleum gas-air mixture can be ignited in the combustion chamber in the conventional manner.

FIGS. 3 and 4 show a second exemplary embodiment of the invention. An essential difference from the previous exemplary embodiment is that the liquefied petroleum gas is not ejected from the metering space 12 by means of a chargeable energy accumulator (spring 21), but instead directly by the pressure of the fuel.

Just as in the preceding embodiment, the displacement member 16 is constructed as a linearly movable piston located in a cylinder 17 that is part of the metering space 12. The cylinder 17 encloses a fixed volume 12 that is connected to or cut off from the fuel tank 5 and the combustion chamber 2 via respective discrete valve members 13, 14. In the standby position of FIG. 3, the valve 13 for connecting to the fuel tank is opened and the valve 14 for connecting to the combustion chamber 14 is closed.

A branch line 20 leads from the connection of the fuel tank 5 and valve member 13 to an end of the cylinder 17 facing away from the valve members 13, 14. The branch line 20 connects an upper end of the piston-like displacement member 16 to the fuel tank 5.

An adjustment mechanism 15a by which the upper stop 15 for the displacement member 16 can be adjusted, depending in particular on the temperature, the air pressure, the gas pressure and/or the gas bottle fill level, is also arranged in this upper end area of the cylinder 17.

The piston 16 is also tensioned by means of a spring (not shown) into its upper stop position in the direction of the force FV, which is symbolized by the upward-directed arrow in FIG. 3. In this starting position according to FIG. 3, the pressure of the fuel tank 5 is present in the cylinder 17 both above and below the piston 16. The spring force only serves to provide a defined positioning of the piston 16 in a starting position. The force of the positioning spring can accordingly be relatively small.

A triggering process for the fastener driving tool takes place by changing over the valves 13, 14 to the respective opposite position. Thereby the lower part of the cylinder 17 and the fixed part of the metering space 12, which is connected to the valve 14, are connected to the combustion chamber 2, in which there is a considerably lower pressure (ambient pressure). Above the piston 16, the cylinder 17 is subjected via the line 20 to the pressure in the fuel tank 5. Thereby the piston 16 is accelerated downwards according to the drawings, or in the direction of the fixed space 12, pressing the liquefied petroleum gas out of the lower part of the cylinder 17 into the combustion chamber 2. After this process, the piston 16 has reached a lower stop position shown in FIG. 4. According to this process, the displacement member 16 is driven directly by the pressure of the fuel in the tank 5.

For clarity, the volume areas in which the liquefied petroleum gas is in equilibrium in the liquid phase or under high-pressure are shown in FIGS. 3 and 4 with crosshatching.

It is understood that, depending on requirements, it is possible in each of the above-described exemplary embodiments to provide either a discrete arrangement of two valves (13, 14 in FIG. 3) or the arrangement of a three-way valve (18 in FIG. 2) with two switching positions.

1. A fastener driving tool, comprising
a tank for storing a fuel,
a combustion chamber connected to the tank, wherein the combustion chamber has a movable piston for powering a driving plunger, and
a metering device arranged between the tank and the combustion chamber,
wherein a defined quantity of fuel can be transported by means of the metering device from a metering space into the combustion chamber, and
wherein the metering device comprises a movable displacement member for ejecting the fuel out of the metering space,
and wherein the movement of the displacement member can be driven by a pressure of the fuel as the energy source.

2. The fastener driving tool according to claim 1, wherein the displacement member comprises a linearly movable reciprocating piston that is guided in a cylinder forming at least part of the metering space.

3. The fastener driving tool according to claim 1, wherein the displacement member comprises an actuation plunger.

4. The fastener driving tool according to claim 1, wherein the displacement member comprises an elastic wall.

5. The fastener driving tool according to claim 1, wherein the displacement member comprises a drive unit comprising a mechanical energy accumulator, the energy accumulator being recharged by a pressure of the fuel.

6. The fastener driving tool according to claim 5, wherein the energy accumulator comprises a mechanical spring, a pneumatic spring or a magnetic spring.

7. The fastener driving tool according to claim 1, wherein the movement of the displacement member can be driven directly by a pressure of the fuel via a connection to the tank.

8. The fastener driving tool according to claim 1, wherein the displacement member is held in an initial position under application of force by means of a spring.

9. The fastener driving tool according to claim 1, wherein the metering device comprises at least one electrically operated valve member, wherein the metering space can be blocked off from the combustion chamber by the valve member.

10. The fastener driving tool according to claim 9, wherein the valve member comprises a 3-way valve.

11. The fastener driving tool according to claim 1, wherein the defined fuel quantity can be adjusted by means of an adjustable stop of the displacement member.

12. The fastener driving tool according to claim 2, wherein the displacement member comprises a drive unit comprising a mechanical energy accumulator, the energy accumulator being recharged by a pressure of the fuel.

13. The fastener driving tool according to claim 3, wherein the displacement member comprises a drive unit comprising a mechanical energy accumulator, the energy accumulator being recharged by a pressure of the fuel.

14. The fastener driving tool according to claim 4, wherein the displacement member comprises a drive unit comprising a mechanical energy accumulator, the energy accumulator being recharged by a pressure of the fuel.

15. The fastener driving tool according to claim 12, wherein the energy accumulator comprises a mechanical spring, a pneumatic spring or a magnetic spring.

16. The fastener driving tool according to claim 13, wherein the energy accumulator comprises a mechanical spring, a pneumatic spring or a magnetic spring.

17. The fastener driving tool according to claim 10, wherein the 3-way valve has two switching positions.

18. The fastener driving tool according to claim 2, wherein the metering device comprises at least one electrically operated valve member, wherein the metering space can be blocked off from the combustion chamber by the valve member.

19. The fastener driving tool according to claim 18, wherein the valve member comprises a 3-way valve.

20. The fastener driving tool according to claim 2, wherein the displacement member is held in an initial position under application of force by means of a spring.
